(19) United States
(12) Patent Application Publication
(10) Pub. No.: US 2010/0078393 A1
(43) Pub. Date: Apr. 1, 2010

(54) BIOCIDAL COMPOSITIONS AND METHODS OF USE

(76) Inventor: Bei Yin, Buffalo Grove, IL (US)

Correspondence Address: The Dow Chemical Company, Intellectual Property Section, P.O. Box 1967, Midland, MI, 48641-1967, US

(21) Appl. No.: 12/243,028

(22) Filed: Oct. 1, 2008

(51) Int. Cl. A01N 59/00; A01N 35/02; A01N 43/76; C02F 1/68; C02F 103/42; C02F 103/16; C02F 103/28; C02F 103/34; C02F 103/14; C02F 3/28; A01P 1/00

(52) U.S. Cl. 210/764; 514/705; 514/374; 514/375; 424/613

(57) ABSTRACT

Provided is a biocidal composition comprising glutaraldehyde and an oxazolidine biocidal compound. The composition is useful for controlling microorganisms in aqueous or water containing systems such as found in oil and natural gas production.

### FIELD OF THE INVENTION

The invention relates to biocidal compositions and methods of their use for the control of microorganisms in aqueous and water containing systems.

### BACKGROUND OF THE INVENTION

Protecting water-containing systems from microbial contamination is critical to the success of many production processes, especially oil or natural gas production operations. In oil and gas production, microorganism contamination from both aerobic and anaerobic bacteria can cause serious problems such as reservoir souring (mainly caused by anaerobic sulfate-reducing bacteria (SRB)), microbiologically influenced corrosion (MIC) on metal surfaces of equipment and pipelines, and degradation of polymer additives.

Microbial contamination can occur anywhere throughout oil and gas operations including in injection water, produced water, downhole, near bore areas, in deaeration towers, in transmission pipelines, in oil and gas storage tanks, and in functional water-based fluids such as drilling muds, completion or workover fluids, stimulation fluids, and fracturing fluids.

Biocide treatments are essential and used for disinfecting and preserving aqueous systems in oil and gas applications. However not all biocides are effective over a wide range of microorganisms and/or temperatures. In oil and gas applications, the high temperature (up to 120° C. or higher) and presence of H₂S in down hole environments become big and unique challenges for biocide treatments.

Glutaraldehyde is a fast acting biocide and is one of the main biocides used for oil/gas field injection and produced water/fluids treatment. However, it is not stable under certain conditions such as high temperature (e.g. 80° C. and above). And therefore, cannot provide long term microbial control for a downhole environment. As a result, there is a need for thermally stable, fast acting, and long lasting biocides for oil and gas applications, including for down-hole treatment for anaerobic SRB control.

### BRIEF SUMMARY OF THE INVENTION

In one aspect, the invention provides synergistic biocidal compositions. The compositions are useful for controlling microbial growth in aqueous or water containing systems, and are particularly suited for applications in the oil and natural gas industry. The compositions of the invention comprise glutaraldehyde together with an oxazolidine biocidal compound.

In a second aspect, the invention provides a method for controlling microorganisms in aqueous or water containing systems. The method comprises treating the system with the biocidal compositions described herein.

### DETAILED DESCRIPTION OF THE INVENTION

As noted above, the invention provides biocidal compositions and methods of using them in the control of microorganisms. The compositions comprise glutaraldehyde together with a biocidal oxazolidine compound. It has surprisingly been discovered that the combination of glutaraldehyde and an oxazolidine are synergistic when used for microorganism control in aqueous or water containing media. That is, the combined materials result in improved biocidal properties than would otherwise be expected based on their individual performance at the particular use-concentration. The observed synergy permits reduced amounts of the materials to be used to achieve acceptable biocidal properties, thus potentially reducing environmental impact and materials cost.

In addition to exhibiting synergy, the compositions of the invention are also effective for controlling a wide range of microorganism types, including both aerobic and anaerobic microorganisms. Further, the compositions are functional at both low and high temperature and for extended time periods. They also maintain their efficacy in sulfide containing environments, such as those containing sulfide ion. As a result of these attributes, the compositions are particularly useful in the oil and natural gas industry. In these industries, biocidal agents are needed that are capable of controlling both aerobic and anaerobic microorganisms over varying temperature ranges, and that continue to be effective even when sulfides are present.

For the purposes of this specification, the meaning of “microorganism” includes, but is not limited to, bacteria, fungi, algae, and virus. Preferred microorganisms against which the compositions are effective are bacteria, and more preferably, SRB. The words “control” and “controlling” should be broadly construed to include within their meaning, and without being limited thereto, inhibiting the growth or propagation of micro-organisms, killing microorganisms, disinfection, and/or preservation against re-growth.

Suitable oxazolidine compounds for use in the invention include, but are not limited to, monocyclic oxazolidines such as 4,4-dimethyoxazolidine (available from The Dow Chemical Company), N-methyl-1,3-oxazolidine, N-ethylol-1,3-oxazolidine, 5-methyl-1,3-oxazolidine, 4-ethyl-4-hydroxymethyloxazolidine, 4-ethyloxazolidine, and 4-methyl-4-ethyloxazolidine. 4,4-Dimethyoxazolidine is a preferred monocyclic oxazolidine.

Suitable oxazolidine compounds also include bicyclic oxazolidines, including 1-aza-3,7-bicyclo[3.3.0]octane optionally substituted with C₁-C₆ alkyl, C₁-C₆ alkoxy, or hydroxy(C₁-C₆ alkyl), such as 7-ethylbicyclooxazolidine (5-ethyl-1-aza-3,7-dioxabicyclo[3.3.0]octane) (available from The Dow Chemical Company), 5-hydroxymethoxymethyl-1-aza-3,7-dioxabicyclo[3.3.0]octane (available from International Specialty Products), 5-hydroxymethyl-1-aza-3,7-dioxabicyclo[3.3.0]octane (available from International Specialty Products), 5-hydroxypoly(methyleneoxymethyl-1-aza-dioxabicyclo(3.3.0)octane (available from International Specialty Products), and 1-aza-3,7-dioxa-5-methylol-(3.3.0)-bicyclooctane. 7-Ethylbicyclooxazolidine is a preferred bicyclic oxazolidine.

Suitable oxazolidine compounds further include bisoxazolidines such as N,N-methylenebis(5-methyl-oxazolidine) (available from Halliburton) and bis-(4,4′-tetramethyl-1,3-oxazolidin-3-yl)-methane.

Suitable oxazolidine compounds additionally include polyoxazolidines.

Of course, more than one oxazolidine compound can be combined for use in the present invention; in such cases, ratios and concentrations are calculated using the total weight of all oxazolidine compounds.

Preferably, the glutaraldehyde:oxazolidine weight ratio in the compositions of the invention is between about 50:1 to 1:50, more preferably 30:1 to 1:30, and even more preferably 20:1 to 1:20.

In some preferred embodiments, the weight ratio of glutaraldehyde to oxazolidine compound is between about 30:1 and about 1:50, more preferably between about 20:1 and about 1:30, even more preferably between about 10:1 and about 1:20. In further embodiments, the weight ratio is between about 10:1 and about 1:15 or between about 6:1 and about 1:15 or between about 6:1 and about 1:9. The embodiments of this paragraph are especially preferred where the oxazolidine is a monocyclic oxazolidine, such as 4,4-dimethyoxazolidine. These embodiments are also preferred when the microorganism being controlled is anaerobic, such as SRB. These embodiments are also preferred where biocidal activity is needed at elevated temperature.

In further preferred embodiments, particularly suited for use against aerobic bacteria, the weight ratio of glutaraldehyde to oxazolidine compound is between about 1:6 and about 1:15. This embodiment is also preferred where the oxazolidine is a monocyclic oxazolidine, such as 4,4-dimethyoxazolidine.

In still other preferred embodiments, the weight ratio of glutaraldehyde to oxazolidine compound is between about 30:1 and about 1:30, more preferably between about 20:1 and about 1:20. The embodiments of this paragraph are especially preferred where the oxazolidine is a bicyclic oxazolidine, such as 7-ethylbicyclooxazolidine. These embodiments are also preferred when the microorganism being controlled is anaerobic, such as SRB.

In yet further preferred embodiments, particularly suited for use against aerobic bacteria, the weight ratio of glutaraldehyde to oxazolidine compound is between 1:6 and 1:8. This embodiment is also preferred where the oxazolidine is a bicyclic oxazolidine, such as 7-ethylbicyclooxazolidine.

The compositions of the invention are useful for controlling both aerobic and anaerobic microorganisms in oil and natural gas applications. In some embodiments, the compositions are preferably used against anaerobic microorganisms (preferably against anaerobic bacteria).

The compositions of the invention are suitable for use over a wide temperature range. In some further preferred embodiments, the compositions are used in aqueous or water containing systems at a temperature of 37° C. or greater, more preferably 60° C. or greater, and even more preferably 80° C. or greater. The compositions are further effective when a source of sulfide (e.g., hydrogen sulfide) is present in the aqueous or water containing system.

Examples of oil and natural gas systems where the compositions of the invention can be used include, for instance, oil and gas field injection and produced water and functional fluids, oil and gas wells, oil and gas operation, separation, storage, and transportation systems, oil and gas pipelines, oil and gas vessels, and fuel.

The blends may also be used for controlling microorganisms in other industrial water and water containing/contaminated matrixes, such as cooling water, boiler water, pulp and paper mill water, other industrial process water, ballast water, wastewater, metalworking fluids, latex, paint, coatings, adhesives, inks, tape joint compounds, personal care and household products, or a system used therewith. In addition, the blends may be employed in other areas where Glutaraldehyde is used as a biocide and reduced loadings are desired.

A person of ordinary skill in the art can readily determine, without undue experimentation, the concentration of the composition that should be used in any particular application. By way of illustration, in some embodiments for oil and gas injection, it is preferred that active concentrations of the composition ranging from about 10 to about 500 ppm by weight, preferably about 30 to about 300 ppm, are used for top side treatment (where the temperature is usually low and aerobic bacteria are likely prevalent), and active concentrations of from about 30 to about 1000 ppm, preferably about 50 to about 500 ppm, for downhole treatment (where the temperature is usually high and anaerobic bacterial are more likely prevalent).

The components of the composition can be added to the aqueous or water containing system separately, or preblended prior to addition. A person of ordinary skill in the art can readily determine the appropriate method of addition. The composition can be added to the system with other additives such as, but not limited to, surfactants, ionic/nonionic polymers and scale, corrosion inhibitors, oxygen scavengers. Additional biocides may also be added, such as quaternary ammonium compounds, tetrakis(hydroxymethyl)phosphonium salts and tris hydroxymethyl phosphine, 2,2-Dibromo-3-nitrilopropionamide (DBNPA), 2-Bromo-2-nitropropane-1,3-diol (Bronopol), 5-chloro-2-methyl-4-isothiazolin-3-one, 2-methyl-4-isothiazolin-3-one (CMIT/MIT), 2-methyl-4-isothiazolin-3-one, Tris(hydroxmethyl)nitromethane, 1-(3-chloroallyl)-3,5,7,-triaza-1-azonia-adamantane chloride, 1,2-benzisothiazolin-3-one, o-phthalaldehyde, formaldehyde, triazine, 2,6-dimethyl-m-dioxan-4-ol acetate, oxidants such as chlorine, chlorine dioxide, peroxides, peracetic acid, ammonium bromide, sodium bromide, sodium hypochlorite, sodium hypobromite, 1-bromo-3-chloro-5,5-dimethylhydantoin (BCDMH), chloramine.

The following examples are illustrative of the invention but are not intended to limit its scope.

### EXAMPLES

The synergy indexes reported in the following examples are calculated using the following equation:

Synergy Index=Ca/CA+Cb/CB

where Ca: Concentration of biocide A required to achieve a certain level or complete bacterial kill when used in combination;

CA: Concentration of biocide A required to achieve a certain level or complete bacterial kill when used alone;

Cb: Concentration of biocide B required to achieve a certain level or complete bacterial kill when used in combination; and

CB: Concentration of biocide B required to achieve a certain level or complete bacterial kill when used alone.

A synergy index (SI) of 1 indicates additivity, a synergy index of less than 1 indicates synergy, and a synergy index greater than 1 indicates antagonism.

Various methods known to those skilled in the art can be used for evaluating biocidal efficacy. In some of the examples below, a serial dilution technique is used, which determines viable bacteria remaining after a treatment regimen. The method is based or adapted (e.g., for high temperature testing or for the presence of sulfide) from the methodology described in inventor's pending international application PCT/US08/075755, filed Sep. 10, 2008, which is incorporated herein by reference.

### Example 1

### Synergy of Glutaraldehyde/Oxazolidine Against Aerobic Bacteria

A sterile NaCl solution (0.85%) is contaminated with bacterial inoculums at final bacterial concentration of approximately 10⁶ CFU/ml. Then, biocide solution (single or in combination) is added into the bacterial suspension at various concentrations and immediately mixed well. After the mixtures are incubated at 37° C. for 1 hour, the viable bacteria left in the solution are determined. Bacterial log reduction is then calculated. Table 1 below compares the dosages required to achieve 3 log bacterial reduction when glutaraldehyde and 4,4-dimethyl-oxazolidine are used alone and in combination at active weight ratio of 1:6.

TABLE 1
Biocidal efficacy of glutaraldehyde, 4,4-dimethyl-oxazolidine and their
combination

Concentration required to
achieve 3 log bacterial reduction in 1 hour
(ppm, active)

| | Used alone | | Used in combination | | |
|---|---|---|---|---|---|
| | | 4,4-dimethyl- | | 4,4-dimethyl- | Synergy |
| Bacteria | Glutaraldehyde | oxazolidine | Glutaraldehyde | oxazolidine | index |
| Pseudomonas aeruginosa | 44.5 | 296.6 | 18.6 | 111.3 | 0.79 |
| ATCC 10145 | | | | | |
| Staphylococcus aureus | 44.5 | 296.6 | 18.6 | 111.3 | 0.79 |
| ATCC 6538 | | | | | |
| Enterobacter aerogenes | 44.5 | 296.6 | 18.6 | 111.3 | 0.79 |
| ATCC 13048 | | | | | |
| Klebsiella pneumoniae | 44.5 | 197.8 | 12.4 | 74.2 | 0.65 |
| ATCC 8308 | | | | | |
| Escherichia coli ATCC | 44.5 | 197.8 | 18.6 | 111.3 | 0.98 |
| 11229 | | | | | |
| Salmonella choleraesius | 44.5 | 197.8 | 18.6 | 111.3 | 0.98 |
| ATCC 10708 | | | | | |
| Pseudomonas putida | 44.5 | 296.6 | 18.6 | 111.3 | 0.79 |
| ATCC 49128 | | | | | |
| Bacillus subtillus ATCC | 44.5 | 296.6 | 18.6 | 111.3 | 0.79 |
| 8473 | | | | | |

As shown in the table 1, glutaraldehyde in combination with 4,4-dimethyl-oxazolidine shows a high synergistic effect and much lower dosages are therefore needed for good bacterial control when the biocides are used in combination instead of separately.

Using the same test evaluation, other ratios of the glutaraldehyde/4,4-dimethyl-oxazolidine combination are tested. The synergy indexes of the biocidal efficacy of these combinations against Pseudomonas aeruginosa ATCC 10145 are summarized in Table 2.

TABLE 2
Synergy index of glutaraldehyde/4,4-dimethyl-oxazolidine
combination's efficacy against Pseudomonas aeruginosa
ATCC 10145 at different ratios.

| Active weight ratio of glutaraldehyde | |
|---|---|
| to 4,4-dimethyl-oxazolidine | Synergy Index |
| 2:1 | 1.53 |
| 1:1 | 1.05 |
| 1:2 | 1.08 |
| 1:4 | 1.14 |
| 1:6 | 0.79 |
| 1:8 | 0.81 |
| 1:10 | 0.83 |
| 1:15 | 0.87 |
| 1:20 | 1.33 |

The combinations of glutaraldehyde with 7-ethyl-bicyclooxazolidine are also tested. Table 3 compares the dosages required to achieve 3 log bacterial reduction when glutaraldehyde and 7-ethyl-bicyclooxazolidine are used alone and in combination at active weight ratio of 1:6.

TABLE 3
Biocidal efficacy of glutaraldehyde, 7-ethyl-bicyclooxazolidine and their
combination

| | Concentration required to | | | | |
|---|---|---|---|---|---|
| | achieve 3 log bacterial reduction in 1 hour (ppm, | | | | |
| | active) | | | | |
| | Used alone | | Used in combination | | |
| | | 7-ethyl- | | 7-ethyl- | Synergy |
| Bacteria | Glutaraldehyde | bicyclooxazolidine | Glutaraldehyde | bicyclooxazolidine | index* |
| Pseudomonas | 44.5 | 296.6 | 18.6 | 111.3 | 0.79 |
| aeruginosa ATCC | | | | | |
| 10145 | | | | | |
| Staphylococcus | 44.5 | 296.6 | 18.6 | 111.3 | 0.79 |
| aureus ATCC 6538 | | | | | |
| Enterobacter | 44.5 | 296.6 | 18.6 | 111.3 | 0.79 |
| aerogenes ATCC | | | | | |
| 13048 | | | | | |
| Klebsiella | 44.5 | 197.8 | 12.4 | 74.2 | 0.65 |
| pneumoniae ATCC | | | | | |
| 8308 | | | | | |
| Escherichia coli | 44.5 | 296.6 | 12.4 | 74.2 | 0.53 |
| ATCC 11229 | | | | | |
| Salmonella | 44.5 | 296.6 | 18.6 | 111.3 | 0.79 |
| choleraesius ATCC | | | | | |
| 10708 | | | | | |
| Pseudomonas putida | 44.5 | 296.6 | 18.6 | 111.3 | 0.79 |
| ATCC 49128 | | | | | |
| Bacillus subtillus | 44.5 | 296.6 | 12.4 | 74.2 | 0.53 |
| ATCC 8473 | | | | | |

The synergy indexes of the biocidal efficacy of other glutaraldehyde/7-ethyl-bicyclooxazolidine combinations against Pseudomonas aeruginosa ATCC 10145 are summarized in Table 4.

TABLE 4
Synergy index of glutaraldehyde/7-ethyl-bicyclooxazolidine
combination's efficacy against Pseudomonas aeruginosa
ATCC 10145 at different ratios.

| Active weight ratio of glutaraldehyde | |
|---|---|
| to 7-ethyl-bicyclooxazolidine | Synergy Index |
| 2:1 | 1.02 |
| 1:1 | 1.05 |
| 1:2 | 1.08 |
| 1:4 | 1.14 |
| 1:6 | 0.79 |
| 1:8 | 0.82 |
| 1:10 | 1.25 |
| 1:15 | 1.30 |
| 1:20 | 1.33 |

### Example 2

### Synergy of Glutaraldehyde/Oxazolidine Against Anaerobic Bacteria

Inside an anaerobic chamber (Bactron III), a deaerated sterile salt solution (3.1183 g of NaCl, 1.3082 mg of NaHCO₃, 47.70 mg of KCl, 72.00 mg of CaCl₂, 54.49 mg of MgSO₄, 172.28 mg of Na2SO₄, 43.92 mg of Na₂CO₃ in 1 L water) is contaminated with an oil field isolated anaerobic SRB consortium at final bacterial concentrations of about 10⁷ CFU/mL. The aliquots of this bacterial suspension are then treated with glutaraldehyde, oxazolidine biocides (4,4-dimethyl-oxazolidine or 7-ethyl-bicyclooxazolidine in this case) or the glutaraldehyde/oxazolidine combinations at different active concentrations. After the mixtures are incubated at 40° C. for 1 hour, the viable bacteria left in the mixture are determined using a serial dilution method. Bacterial log reduction is then calculated. Table 5 compares the dosages required to achieve complete bacterial kill when glutaraldehyde and 4,4-dimethyl-oxazolidine are used alone and in combination.

TABLE 5
Biocidal efficacy of glutaraldehyde, 4,4-dimethyl-oxazolidine
and their combination against SRB

| Concentration required for complete | | | | |
|---|---|---|---|---|
| bacterial kill in 1 hour (ppm, active) | | | | |
| Used alone | | Used in combination | | |
| Glutaral- | 4,4-dimethyl- | | 4,4-dimethyl- | Synergy |
| dehyde | oxazolidine | Glutaraldehyde | oxazolidine | index |
| 26.3 | >1600.0 | 13.2 | 2.4 | <0.50 |
| | | 11.9 | 5.9 | <0.46 |
| | | 17.8 | 15.8 | <0.69 |
| | | 10.5 | 21.1 | <0.41 |
| | | 10.5 | 39.5 | <0.42 |
| | | 5.3 | 43.9 | <0.23 |

As can be seen from Table 5, high synergistic effects of the Glutaraldehyde/4,4-dimethyl-oxazolidine combinations are demonstrated in this test. The biocidal efficacy of glutaraldehyde, 7-ethyl-bicyclooxazolidine and their combination at various active weight ratios are summarized in Table 6. The data in Table 6 show a high synergistic effect of glutaraldehyde/7-ethyl-bicyclooxazolidine combination against anaerobic SRB.

TABLE 6
Biocidal efficacy of glutaraldehyde, 7-ethyl-bicyclooxazolidine and their
combination against SRB

| Concentration required for | | | | | |
|---|---|---|---|---|---|
| 3 log bacterial kill in 2 hours (ppm, active) | | | | | |
| Used alone | | Used in combination | | | |
| | 7-ethyl- | weight | | 7-ethyl- | Synergy |
| Glutaraldehyde | bicyclooxazolidine | ratio | Glutaraldehyde | bicyclooxazolidine | index |
| 8.9 | >2025 | 20:1 | 5.9 | 0.3 | <0.67 |
| | | 10:1 | 5.9 | 0.6 | <0.67 |
| | | 5:1 | 5.9 | 1.2 | <0.67 |
| | | 2:1 | 8.9 | 4.4 | <1.00 |
| | | 1:1 | 5.9 | 5.9 | <0.67 |
| | | 1:2 | 5.9 | 11.9 | <0.67 |
| | | 1:5 | 5.9 | 29.6 | <0.68 |
| | | 1:10 | 4.0 | 39.5 | <0.46 |
| | | 1:20 | 2.6 | 52.7 | <0.32 |

### Example 3

### Synergy of Glutaraldehyde/Oxazolidine Against Anaerobic Bacteria at Elevated Temperature

In this example, the biocidal effectiveness of glutaraldehyde, oxazolidine, and their combinations are evaluated at 80° C. over 5 days. The biocides are challenged with 10⁵ CFU/mL of oilfield SRB consortium in the presence of 10 ppm sulfide. The biocide solutions are re-challenged with the SRB consortium and sulfide at day 3 and 4. Table 7 shows the synergy index results for the 5 day test. The results in Table 7 reveal that the glutaraldehyde/4,4-dimethyl-oxazolidine combination is synergistic at 80° C., with SRB and sulfide challenge.

TABLE 7
Synergy index of glutaraldehyde/4,4-dimethyl-oxazolidine combination
for high temperature and sulfide environment application

| | |
|---|---|
| Active weight ratio | |
| (Glutaraldehyde:4,4- | Synergy index |

| dimethyl-oxazolidine) | 2 hr | 3 days | 4 days | 5 days |
|---|---|---|---|---|
| 5.5:1 | <0.5 | 0.2 | 0.2 | <0.1 |
| 2:1 | 0.5 | 0.2 | 0.1 | <0.1 |
| 1:1.1 | 0.5 | 0.2 | 0.1 | <0.1 |
| 1:2 | 0.4 | 0.1 | 0.1 | <0.1 |
| 1:3.8 | 0.4 | 0.2 | <0.1 | <0.1 |
| 1:8.3 | 1.1 | 0.4 | <0.1 | <0.1 |

While the invention has been described above according to its preferred embodiments, it can be modified within the spirit and scope of this disclosure. This application is therefore intended to cover any variations, uses, or adaptations of the invention using the general principles disclosed herein. Further, the application is intended to cover such departures from the present disclosure as come within the known or customary practice in the art to which this invention pertains and which fall within the limits of the following claims.

What is claimed is:

1. A composition comprising:
glutaraldehyde; and
an oxazolidine biocidal compound.

2. A composition according to claim 1 wherein the weight ratio of glutaraldehyde to oxazolidine biocidal compound is between about 50:1 and 1:50.

3. A composition according to claim 1 wherein the weight ratio of glutaraldehyde to oxazolidine biocidal compound is between about 20:1 and 1:20.

4. A composition according to claim 1 wherein the oxazolidine biocidal compound is a monocyclic oxazolidine.

5. A composition according to claim 4 wherein the monocyclic oxazolidine is 4,4-dimethyoxazolidine, N-methyl-1,3-oxazolidine, N-ethylol-1,3-oxazolidine, 5-methyl-1,3-oxazolidine, 4-ethyl-4-hydroxymethyloxazolidine, 4-ethyloxazolidine, 4-methyl-4-ethyloxazolidine, or mixtures of two or more thereof.

6. A composition according to claim 1 wherein the oxazolidine biocidal compound is a bicyclic oxazolidine.

7. A composition according to claim 6 wherein the bicyclic oxazolidine is 1-aza-3,7-bicyclo[3.3.0]octane optionally substituted with C₁-C₆ alkyl, C₁-C₆ alkoxy, or hydroxy(C₁-C₆ alkyl).

8. A composition according to claim 7 wherein the bicyclic oxazolidine is 7-ethylbicyclooxazolidine, 5-hydroxymethoxymethyl-1-aza-3,7-dioxabicyclo[3.3.0]octane, 5-hydroxymethyl-1-aza-3,7-dioxabicyclo[3.3.0]octane, 5-hydroxypoly(methyleneoxymethyl-1-aza-dioxabicyclo(3.3.0)octane, 1-aza-3,7-dioxa-5-methylol-(3.3.0)-bicyclooctane, or mixtures of two or more thereof.

9. A composition according to claim 8 wherein the oxazolidine biocidal compound is a mixture of 5-hydroxymethoxymethyl-1-aza-3,7-dioxabicyclo[3.3.0]octane, 5-hydroxymethyl-1-aza-3,7-dioxabicyclo[3.3.0]octane, and 5-hydroxypoly(methyleneoxymethyl-1-aza-dioxabicyclo(3.3.0)octane.

10. A composition according to claim 1 wherein the oxazolidine biocidal compound is a bisoxazolidine.

11. A composition according to claim 10 wherein the bisoxazolidine is N,N-methylenebis(5-methyl-oxazolidine), bis-(4,4′-tetramethyl-1,3-oxazolidin-3-yl)-methane, or mixtures of two or more thereof.

12. A composition according to claim 1 wherein the oxazolidine biocidal compound is a polyoxazolidine.

13. A composition according to claim 1 further comprising one or more surfactants, ionic/nonionic polymers and scale, corrosion inhibitors, oxygen scavengers or additional biocides.

14. A composition according to claim 13 wherein the additional biocides are selected from quaternary ammonium compounds, tetrakis(hydroxymethyl)phosphonium salts and tris hydroxymethyl phosphine, 2,2-Dibromo-3-nitrilopropionamide (DBNPA), 2-Bromo-2-nitropropane-1,3-diol (Bronopol), 5-chloro-2-methyl-4-isothiazolin-3-one, 2-methyl-4-isothiazolin-3-one (CMIT/MIT), 2-methyl-4-isothiazolin-3-one, Tris(hydroxmethyl)nitromethane, 1-(3-chloroallyl)-3,5,7,-triaza-1-azonia-adamantane chloride, 1,2-benzisothiazolin-3-one, o-phthalaldehyde, formaldehyde, triazine, 2,6-dimethyl-m-dioxan-4-ol acetate, oxidants such as chlorine, chlorine dioxide, peroxides, peracetic acid, ammonium bromide, sodium bromide, sodium hypochlorite, sodium hypobromite, 1-bromo-3-chloro-5,5-dimethylhydantoin (BCDMH), chloramine, and mixtures of two or more thereof.

15. A method for controlling microorganisms in an aqueous or water containing system, the method comprising treating the system with a composition according to claim 1.

16. A method according to claim 15 wherein the aqueous or water containing system is used or is present in oil and or gas production.

17. A method according to claim 16 wherein oil and gas production comprises oil and gas field injection and produced water and functional fluids, oil and gas wells, oil and gas operation, separation, storage, and transportation systems, oil and gas pipelines, oil and gas vessels, or fuel.

18. A method according to claim 15 wherein the aqueous or water containing system is cooling water, boiler water, pulp and paper mill water, other industrial process water, ballast water, wastewater, metalworking fluids, latex, paint, coatings, adhesives, inks, tape joint compounds, personal care and household products, or a system used therewith.

19. A method according to claim 15 wherein the microorganisms are anaerobic bacteria.

20. A method according to claim 15 wherein the aqueous or water containing system is at 37° C. or above.
